(19) United States
(12) Patent Application Publication
(10) Pub. No.: US 2021/0326730 A1
(43) Pub. Date: Oct. 21, 2021

(54) METHOD FOR INFORMATION COMPLETION, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Yaqing WANG, Beijing (CN); Dejing DOU, Beijing (CN)

(21) Appl. No.: 17/363,101

(22) Filed: Jun. 30, 2021

(30) Foreign Application Priority Data
Dec. 25, 2020 (CN) 202011569025.5

(51) Int. Cl. G06N 5/04; G06F 40/174; G06N 20/00

(52) U.S. Cl. CPC G06N 5/04; G06N 20/00; G06F 40/174

(57) ABSTRACT

A method for information completion, an electronic device and a storage medium, related to the fields of artificial intelligence, big data, deep learning and the like, are provided. The method includes: acquiring an actual information form and an initialization information form, wherein the actual information form includes an information form which is filled out by a plurality of users and in which target information is missing, and the initialization information form is an information form in which there is target information at each target information position; performing an adjustment on the initialization information form by utilizing a similarity between the users, a low-rank constraint of the initialization information form and a difference between the initialization information form and the actual information form, to obtain an adjusted information form; and supplementing target information in the adjusted information form to a position, in the actual information form.

### CROSS-REFERENCE TO RELATED APPLICATION

This application claims priority to Chinese patent application No. 202011569025.5, filed on Dec. 25, 2020, which is hereby incorporated by reference in its entirety.

### TECHNICAL FIELD

The present disclosure relates to the field of data processing, particularly to the fields of artificial intelligence, big data, deep learning and the like.

### BACKGROUND

In a case where a questionnaire is collected, the situation that the answers of partial questionnaires are missing may be usually encountered. For example, a first user who participated in a questionnaire to fill out missed a second question, and relevant technical solutions include: one of calculating the average of the answers to the second question of all other users who participated in the questionnaire to fill out for completing, calculating the average of all answers of the first user who participated in the questionnaire to fill out for completing, and calculating the average of all answers of other users who participated in the questionnaire to fill out for completing.

### SUMMARY

The present disclosure provides a method and apparatus for information completion, a device, a storage medium and a computer program product.

According to one aspect of the present disclosure, there is provided a method for information completion, which may include:

acquiring an actual information form and an initialization information form, wherein the actual information form includes an information form which is filled out by a plurality of users and in which target information is missing, and the initialization information form is an information form in which there is target information at each target information position;

performing an adjustment on the initialization information form by utilizing a similarity between the users, a low-rank constraint of the initialization information form and a difference between the initialization information form and the actual information form, to obtain an adjusted information form; and

supplementing target information in the adjusted information form to a position where corresponding target information is missing, in the actual information form.

According to another aspect of the present disclosure, there is provided an apparatus for information completion, which may include:

an information form acquisition module configured for acquiring an actual information form and an initialization information form, wherein the actual information form includes an information form which is filled out by a plurality of users and in which target information is missing, and the initialization information form is an information form in which there is target information at each target information position;

an initialization information form adjustment module configured for performing an adjustment on the initialization information form by utilizing a similarity between the users, a low-rank constraint of the initialization information form and a difference between the initialization information form and the actual information form, to obtain an adjusted information form; and

a target information completion module configured for supplementing target information in the adjusted information form to a position where corresponding target information is missing, in the actual information form.

According to a third aspect, an embodiment of the present disclosure provides an electronic device, including:

at least one processor; and

a memory communicatively connected to the at least one processor;

wherein,

the memory stores instructions executable by the at least one processor, the instructions being executed by the at least one processor to enable the at least one processor to perform the method provided by any one of the embodiments of the present disclosure.

According to a fourth aspect, an embodiment of the present disclosure provides a non-transitory computer-readable storage medium storing computer instructions for enabling a computer to perform the method provided by any one of the embodiments of the present disclosure.

According to another aspect of the present disclosure, there is provided a computer program product including computer instructions which, when executed by a processor, cause the processor to perform the method in any one of the embodiments of the present disclosure.

It should be understood that the content described in this section is neither intended to limit the key or important features of the embodiments of the present disclosure, nor intended to limit the scope of the present disclosure. Other features of the present disclosure will be readily understood through the following description.

### BRIEF DESCRIPTION OF THE DRAWINGS

The drawings are used to better understand the scheme and do not constitute a limitation to the present disclosure. In which:

FIG. 1 is a flowchart of a method for information completion according to the present disclosure;

FIG. 2 is a schematic diagram of an actual information form according to the present disclosure;

FIG. 3 is a flowchart of a manner for determining a low-rank constraint according to the present disclosure;

FIG. 4 is a flow diagram of an approximate generalized singular value threshold method according to the present disclosure;

FIG. 5 is a flowchart of solving matrix eigenvalues by using a power method according to the present disclosure;

FIG. 6 is a flowchart of a manner for determining the similarity between respective users according to the present disclosure;

FIG. 7 is a flowchart of a manner for determining the difference between an initialization information form and an actual information form according to the present disclosure;

FIG. 8 is a schematic diagram of an apparatus for information completion according to the present disclosure; and

FIG. 9 is a block diagram of an electronic device used to implement the method for information completion of an embodiment of the present disclosure.

### DETAILED DESCRIPTION

Exemplary embodiments of the present disclosure are described below in combination with the drawings, including various details of the embodiments of the present disclosure to facilitate understanding, which should be considered as exemplary only. Thus, those of ordinary skill in the art should realize that various changes and modifications can be made to the embodiments described here without departing from the scope and spirit of the present disclosure. Likewise, descriptions of well-known functions and structures are omitted in the following description for clarity and conciseness.

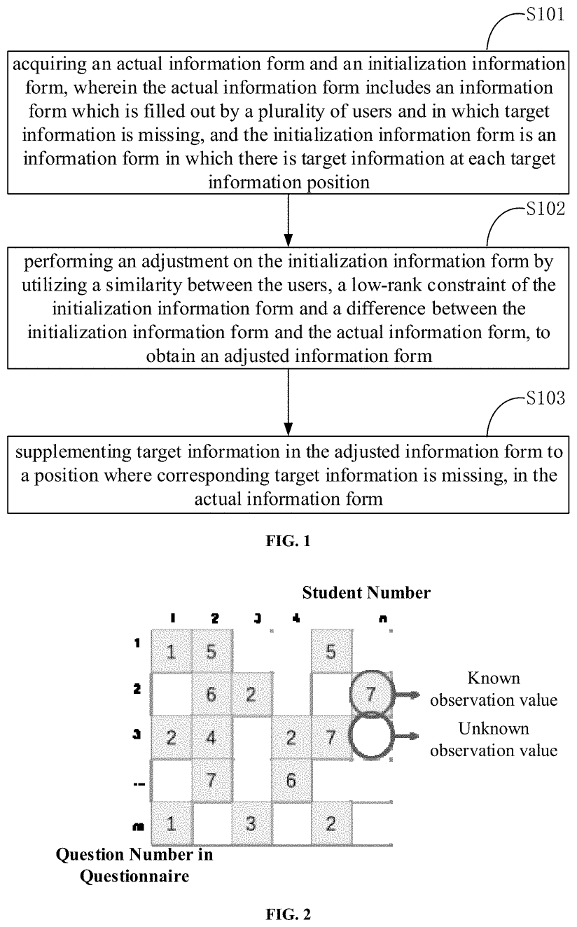

As shown in FIG. 1, the present disclosure provides a method for information completion, which may include:

S101: acquiring an actual information form and an initialization information form, wherein the actual information form includes an information form which is filled out by a plurality of users and in which target information is missing, and the initialization information form is an information form in which there is target information at each target information position;

S102: performing an adjustment on the initialization information form by utilizing a similarity between the users, a low-rank constraint of the initialization information form and a difference between the initialization information form and the actual information form, to obtain an adjusted information form; and

S103: supplementing target information in the adjusted information form to a position where corresponding target information is missing, in the actual information form.

According to the scheme of the present invention, the initialization information form can be adjusted by using a plurality of elements, so that the adjusted information form has high enough similarity with actual information form. Particularly, by using the low-rank constraint information of the information form as an adjustment basis, the time required for performing the adjustment on the initialization information form can be reduced greatly, and the adjustment efficiency is greatly improved without reducing the result precision.

The method provided by the embodiment of the present disclosure may be applied to a scene of completing form information, for example, a student questionnaire, a customer questionnaire, etc. The information form may correspond to a questionnaire. In addition, the method may be applied to a scene of completing other information.

The following is an illustration of a student questionnaire. Questionnaire survey is a questionnaire with answers being numerical values. Illustratively, the numerical values range from 1 to 7. For example, in a case where the answer is 1, it indicates that you cannot agree. In a case where the answer is 7, it indicates that you strongly agree.

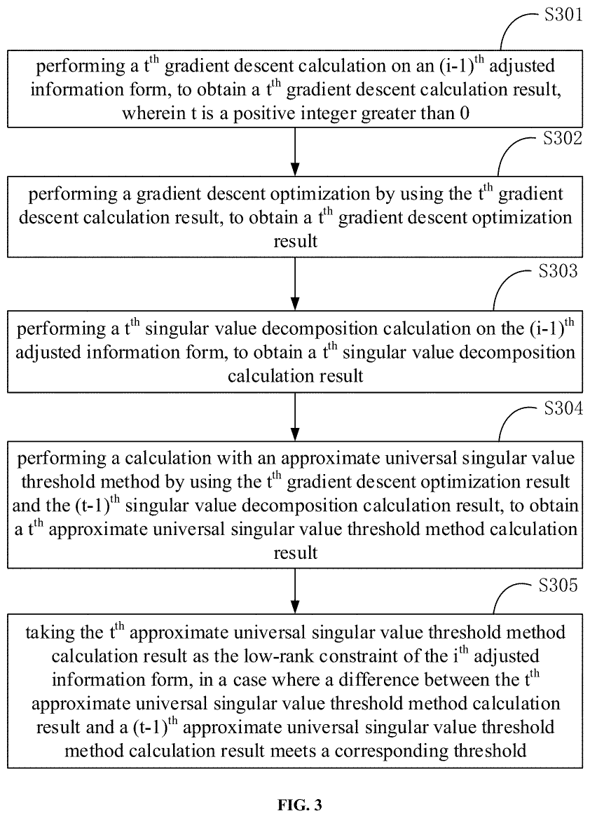

As shown in combination with FIG. 2, the actual information form may correspond to an actual questionnaire filled out by a plurality of students (the following text is the same, and the detailed description is omitted), and an actual questionnaire answer information matrix which is horizontally numbered by the students and vertically numbered by the questions may be formed. In the actual questionnaire, there may be some students' missing answers to the questions. The scheme of the present disclosure may be used for solving the supplement problem of the actual questionnaire with missed answers.

An initialization questionnaire may be generated, and the initialization questionnaire may correspond to an initialization information form (the following text is the same, and the detailed description is omitted). The initialization questionnaire may be a questionnaire in which there is answer information at each answer location. The answer information may correspond to target information (the following text is the same, and the detailed description is omitted). In the initialization questionnaire, the answer information for each answer location may be 0 or 7 uniformly, or may be a random number between 1 and 7 or the like, without limitation.

The similarity relationship between respective users can be obtained by learning the correlation between the users participating in filling out the actual questionnaire. For example, for a student questionnaire, there is a high similarity between classmates A and B in the same class in the same school. The similarity between classmates C and D in different cities or even in different countries are low. In a case where the adjustment of the initialization questionnaire is performed, the correlation among the users participating in filling out the actual questionnaire may be taken as one of adjustment bases.

In addition, a plurality of rounds of adjustment can be made to the initialization questionnaire. Before each adjustment, the difference between the answers in the questionnaire after the previous adjustment and the answers at the corresponding positions in the actual questionnaire may be counted. The multi-round adjustment may be terminated on the condition that a predetermined number of adjustments are reached. The answer difference is taken as the relationship between the initialization questionnaire and the actual questionnaire, to form one of the bases for adjustment.

In addition, the questions of the questionnaire are often based on several key points of investigation. Illustratively, the questions of the questionnaire may be about four aspects of learning attitude, classmate relationship, teacher relationship, course outline. Thus, for an initialization questionnaire and/or an actual questionnaire, the entire questionnaire conforms to a matrix low-rank structure. For example, taking the questionnaire described above as an example, the rank of the initialization questionnaire and/or the actual questionnaire may be considered to be 4. A low-rank constraint is performed on the initialization questionnaire and/or the actual questionnaire, to obtain low-rank constraint information. The low-rank constraint information may effectively reduce the amount of calculation for adjusting the initialization questionnaire, so that the whole adjustment efficiency can be improved. Therefore, the low-rank constraint of the above matrix may also be used as one of the bases for adjustment.

The adjustment involved in the embodiment of the present disclosure may include an iterative optimization algorithm, and this algorithm is used for adjustment, so that the questionnaire after iterative optimization has a high enough similarity with the actual questionnaire. Therefore, the adjusted answers in the questionnaire may be supplemented to the positions in the actual questionnaire where the corresponding answers are vacant, so as to implement information completion. The adjusted questionnaire may correspond to an adjusted information form (the following text is the same, and the detailed description is omitted).

According to the scheme of the present invention, the initialization questionnaire may be adjusted by using a plurality of elements, so that the adjusted questionnaire and the actual questionnaire have a high enough similarity. Particularly, by using the low-rank constraint information for the questionnaire as an adjustment basis, the time required for adjusting the initialization questionnaire can be reduced greatly, and the adjustment efficiency can be greatly improved without reducing the result precision.

In one embodiment, the performing the adjustment on the initialization information form by utilizing the similarity between the users, the low-rank constraint of the initialization information form and the difference between the initialization information form and the actual information form may specifically include:

performing the adjustment a plurality of times, and taking an information form obtained after an N^{th} adjustment as the adjusted information form, in a case where the information form obtained after the N^{th} adjustment meets a preset condition, wherein N is a positive integer.

In the embodiment of the present disclosure, the predetermined condition may be that the difference degree between the output result of the N^{th} adjustment and the actual questionnaire meets expectation. That the difference degree meets expectation may refer to: in the questionnaire after the N^{th} adjustment, answer information exceeding a predetermined number or exceeding a predetermined proportion is the same as corresponding answer information in the actual questionnaire. Alternatively, that the difference degree meets expectation may refer to: in the questionnaire after the N^{th} adjustment, the difference between each answer information and corresponding answer information in the actual questionnaire is within an allowable difference. For example, the allowable difference may be that the difference between the answer informations is not greater than 1.

Alternatively, the plurality of adjustments may be a fixed numerical value. Illustratively, it may be 10 times, 100 times, etc. That is, that N reaches the aforementioned fixed numerical value may also be taken as another constraint condition.

Through the above scheme, the initialization questionnaire may be adjusted a plurality of times until the final (N^{th}) adjusted result meets the expectation. Therefore, the accuracy of the adjustment result is assured to meet the requirement.

As shown in FIG. 3, in one embodiment, for an i^{th} adjustment, 0≤i≤N, a manner for determining low-rank constraint information may include:

S301: performing a t^{th} gradient descent calculation on an (i−1)^{th} adjusted information form, to obtain a t^{th} gradient descent calculation result, wherein t is a positive integer greater than 0;

S302: performing a gradient descent optimization by using the t^{th} gradient descent calculation result, to obtain a t^{th} gradient descent optimization result;

S303: performing a t^{th} singular value decomposition calculation on the (i−1)^{th} adjusted information form, to obtain a t^{th} singular value decomposition calculation result;

S304: performing a calculation with an approximate universal singular value threshold method by using the t^{th} gradient descent optimization result and the (t−1)^{th} singular value decomposition calculation result, to obtain a t^{th} approximate universal singular value threshold method calculation result; and

S305: taking the t^{th} approximate universal singular value threshold method calculation result as the low-rank constraint of the i^{th} adjusted information form, in a case where a difference between the t^{th} approximate universal singular value threshold method calculation result and a (t−1)^{th} approximate universal singular value threshold method calculation result meets a corresponding threshold.

As previously mentioned, N adjustments may be performed on the initialization questionnaire. The process of each adjustment may be the same. Taking the i^{th} adjustment process as an example, the process of determining low-rank constraint information in the i^{th} adjustment process is introduced. It will be understood that the object for the i^{th} adjustment is the result of the (i−1)^{th} adjustment.

$${min}_{X} {‖ {P}_{Ω} ( O - X ) ‖}_{F}^{2} + α l ( X ) + β {‖ X ‖}_{*} \qquad ( 1 )$$

For N adjustments, each adjustment may be made according to Formula (1) above. In Formula (1), O may represent an actual questionnaire in the form of a matrix, and X may represent an initialization questionnaire in the form of a matrix or the questionnaire after each adjustment. P_{Ω}(.) may represent a matrix formed by taking (answer information) values at corresponding positions in O and X according to Ω, and Ω may represent positions where a value is non-zero, in O. ∥⋅∥_{F} may represent the F norm of the matrix. l(X) may represent the Laplacian constraint term for X, and the specific calculation process is described in detail below. ∥⋅∥* may represent the kernel norm of the matrix. α and β may represent a hyper-parameter, which is a known parameter.

The singular values need to be calculated in a case where solving the kernel norm. Thus, for each adjustment made according to Formula (1) above, the singular value decomposition (SVD) operation needs to be repeated. The expression of singular value decomposition is X=U diag(σ(X))V^{T}, where U and V represent left and right singular vectors, respectively. σ(X) represents singular values, σ(X)=[σᵢ(X)] and σ₁(X)≥σ₂(X) ≥ . . . ≥σᵢ(X)≥0. i represents calculation times.

The purpose of the above steps of the present disclosure is to reduce the complexity of the questionnaire through low-rank constraint information. Determining the low-rank constraint information may include a plurality of solving processes, each of which is the same. The t^{th} solving process is exemplified below.

For the t^{th} solving process, hyper-parameters η, ρ, v(v∈(0,1)), λ₀, λ, λₜ(λ₍ₜ₋₁₎−λv+λ),

$${c}_{1} ( {c}_{1} = \frac{η - ρ}{4} )$$

are set.

Calculation times t, and p are set. Both t and p are positive integers, and if solved for the first time, t=1 and p=1. For the second solution, t=2 and p=2, and so on.

V₀, and V₁ are set. V₀, and V₁ may represent the right singular vector of the 0^{th} and 1^{st} singular value decompositions, respectively. V₀, and V₁ may be a matrix of n*1.

The right singular vector of the 0^{th} singular value decomposition may be preset.

Similarly, Vₜ may represent the right singular vector of the t^{th} singular value decomposition. Vₜ may be equivalent to \tilde{V}₀, i.e., \tilde{V}₀=Vₜ.

X₁ is set. X₁ may represent a questionnaire during the first solution. X₁ may be a matrix where the values at all positions are 0, i.e., X₁=0.

The calculation process is as follows:

∇F(Xₜ) (2);

F(Xₜ) may be represented as ∥P_{Ω}(O−Xₜ)∥_{F}²+αl(Xₜ)

Formula (2) may represent performing the t^{th} gradient descent calculation on the i^{th} adjusted questionnaire (performing a gradient descent calculation on the first two terms of Formula (1)), to obtain a t^{th} gradient descent calculation result (VF(X)).

$${Z}_{t} = {X}_{t} - \frac{1}{η} ∇ F ( {X}_{t} ) \qquad ( 3 )$$

Formula (3) may represent performing a gradient descent optimization by using the t^{th} gradient descent calculation result, to obtain a t^{th} gradient descent optimization result (Zt).

$$[ {\tilde{X}}_{p} , {\tilde{V}}_{p} ] = Approximate GSVT ( Zt , {\tilde{V}}_{p - 1} , \frac{{λ}_{t}}{η} ) \qquad ( 4 )$$

Formula (4) may represent performing a calculation with an approximate universal singular value threshold method by using the t^{th} gradient descent optimization result (Zt) and the (t−1)^{th} singular value decomposition calculation result (\tilde{V}ₚ₋₁), to obtain a t^{th} threshold method calculation result (\tilde{X}ₚ. Where, in a case where p=1, \tilde{V}ₚ₋₁=\tilde{V}₀.

F(\tilde{X}ₚ)−F(Xₜ)−c1∥\tilde{X}ₚ−Xₜ∥_{F}² (5)

Using Formula (5), in a case where F(\tilde{X}ₚ)−F(Xₜ)−c1∥Xₚ−Xₜ∥_{F}²≤0, it is shown that the difference between the t^{th} threshold method calculation result and the (t−1)^{th} threshold method calculation result meets a corresponding threshold. In this case, the t^{th} threshold value calculation result is used as the low-rank constraint information of the i^{th} adjusted questionnaire.

It can be inferred from Formula (2) that F(\tilde{X}ₚ) can be expressed as ∥P_{Ω}(O−\tilde{X}ₚ)∥_{F}²+αl(\tilde{X}ₚ).

Conversely, if F(\tilde{X}ₚ)−F(Xₜ)−c1∥\tilde{X}ₚ−Xₜ∥_{F}²>0, it needs to make Xₜ₊₁=\tilde{X}ₚ and Vₜ₊₁=\tilde{V}ₚ, and continue the calculation. Until the calculation result of Formula (5) is not greater than 0.

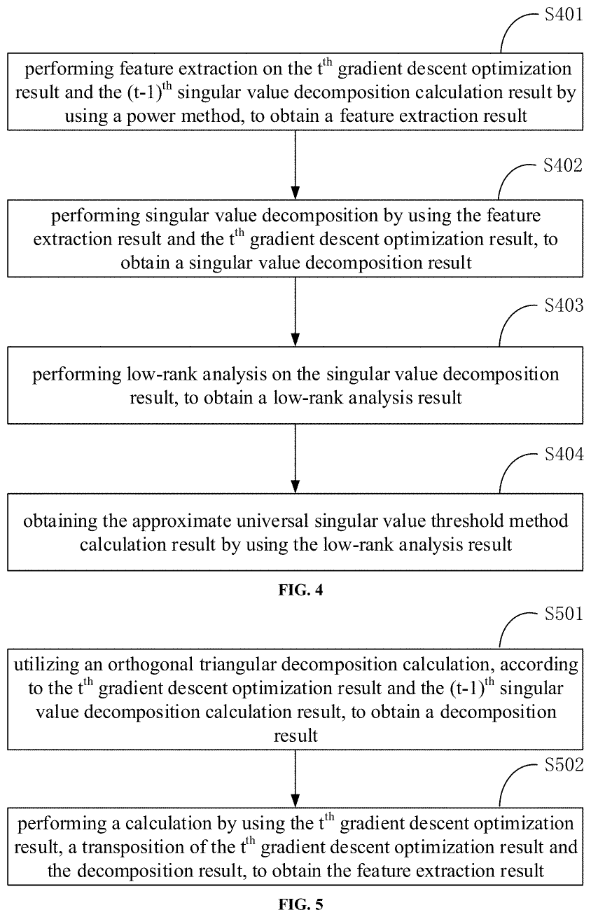

Approximate GSVT (⋅) in Formula (4) above is expressed as an approximate universal singular value threshold method. As shown in combination with FIG. 4, the calculation process is as follows:

S401: performing feature extraction on the t^{th} gradient descent optimization result and the (t−1)^{th} singular value decomposition calculation result by using a power method, to obtain a feature extraction result;

S402: performing singular value decomposition by using the feature extraction result and the t^{th} gradient descent optimization result, to obtain a singular value decomposition result;

S403: performing low-rank analysis on the singular value decomposition result, to obtain a low-rank analysis result; and

S404: obtaining the approximate universal singular value threshold method calculation result by using the low-rank analysis result.

$$Zt , {\tilde{V}}_{p - 1} , \frac{{λ}_{t}}{η} are simplified as Z , R , μ .$$

Further, using Z and R, a power method is used to solve a matrix eigenvalue, to obtain Q. The calculation formula is expressed as

Q=PowerMethod(Z,R) (6)

Singular value decomposition calculation:

[U,Σ,V]=SVD(Q^{T}Z) (7).

In the calculation result of the Formula (7), the value located in the i^{th} row and the i^{th} column in the matrix is counted, the number of the value larger than γ is counted, and the counted result is expressed as a. Wherein, γ is a hyper-parameter.

The sub-matrix formed by the first a columns in the matrix U is expressed as Uₐ, and the sub-matrix formed by the first a columns in the matrix V is expressed as Vₐ.

The individual calculations are performed to obtain each yᵢ*, and i may range from 1 to a. The calculation formula is expressed as:

yᵢ*∈argmin_{yi≥0}½(yᵢ−σᵢ(Z))²+μ\hat{r}(yᵢ) (8)

In Formula (8), 1-(y) is equivalent to the absolute value of yᵢ.

Using Formulas (7), and (8), the low-rank components of (QUₐ, Diag([y₁*, . . . , yₐ*]), Vₐ^{T}) and V can be calculated. Wherein, the low-rank component of X corresponds to \tilde{X}ₚ in Formula (4), and V corresponds to \tilde{V}ₚ in Formula (4).

As shown in combination with the FIG. 5, for solving the matrix eigenvalue by using a power method using Z and R, to obtain Q, the following calculation process may be further adopted:

S501: utilizing an orthogonal triangular decomposition calculation, according to the t^{th} gradient descent optimization result and the (t−1)^{th} singular value decomposition calculation result, to obtain a decomposition result; and

S502: performing a calculation by using the t^{th} gradient descent optimization result, a transposition of the t^{th} gradient descent optimization result and the decomposition result, to obtain the feature extraction result.

Specifically, the above calculation process is as follows:

Z and R are assigned to Y₁, which is represented as Y₁=ZR.

j, as the solution times, has the same meaning as p and t. j is a positive integer which is larger than 1 and less than or equal to J, i.e. corresponding to Y₁, Y₂, . . . , Y_{J}.

A QR decomposition calculation is performed on Yⱼ, to obtain Qⱼ.

Qⱼ₊₁=Z(Z^{T}Qⱼ) (9).

Q_{J} is taken as Q in Formula (6).

Through the above scheme, for the i^{th} adjustment, t times of calculation are needed to enable the questionnaire to achieve gradient descent and meet the requirement of low-rank. After the above calculation, the amount of calculation required for each adjustment is greatly reduced.

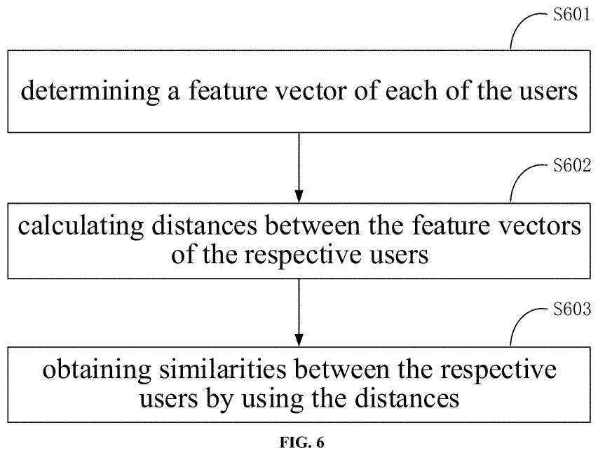

As shown in FIG. 6, in one embodiment, a manner for determining the similarity between respective users involved in S102 may include:

S601: determining a feature vector of each of the users;

S602: calculating distances between the feature vectors of the respective users; and

S603: obtaining similarities between the respective users by using the distances.

According to each user's personal situation, a feature vector representing each user may be calculated. Illustratively, in the embodiment of the present disclosure, the feature vector of each student may be calculated according to information such as gender, nationality, family condition, etc. of each student.

The Euclidean distance of the feature vector of each student is calculated, and the similarity between student i and student j is obtained through a Gaussian similarity calculation formula

$$A ( i , j ) = exp ( \frac{d ( i , j )}{2 {h}^{2}} ) ,$$

where h is a hyper-parameter. The matrix A e R^{m×m} thus records the similarity among m students, the greater the value is, and the higher the similarity is.

Through the above scheme, the similarity between respective users may be calculated.

For the matrix A for recording the similarity, Laplace normalization is performed on the matrix A, to obtain the normalized Laplace matrix

$${L}_{r} . {L}_{r} = {D}_{r}^{- \frac{1}{2}} ( {A}_{r} + I ) {D}_{r}^{- \frac{1}{2}} .$$

Where, Dᵣ=diag(Σⱼ Aᵣ(i,j), I is an identity matrix with diagonal being 1 and remaining positions being 0.

The Laplacian constraint term l(X), l(X)=trace(X^{T} LᵣX) of X can be constructed according to the matrix A for recording the similarity and the normalized Laplacian matrix Lᵣ.

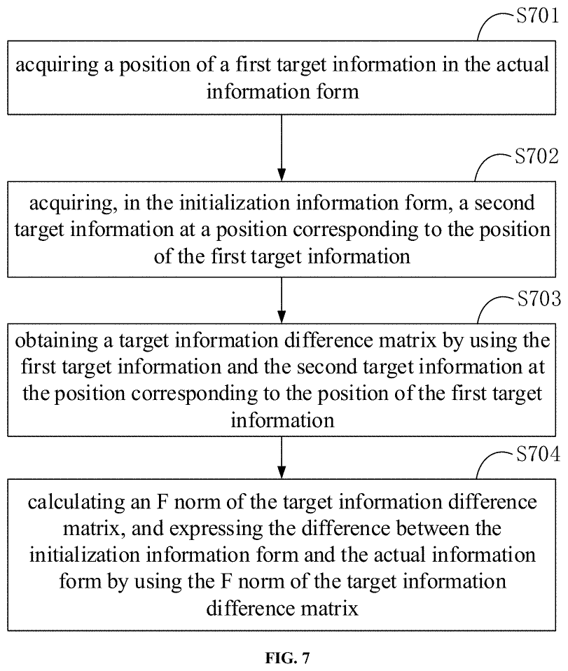

As shown in FIG. 7, in one embodiment, a manner for determining the difference between the initialization information form and the actual information form may include:

S701: acquiring a position of a first target information in the actual information form;

S702: acquiring, in the initialization information form, a second target information at a position corresponding to the position of the first target information;

S703: obtaining a target information difference matrix by using the first target information and the second target information at the position corresponding to the position of the first target information; and

S704: calculating an F norm of the target information difference matrix, and expressing the difference between the initialization information form and the actual information form by using the F norm of the target information difference matrix.

In the step, answer information at each position where an answer exists in the actual questionnaire needs to be acquired. The answer information corresponds to first target information. Each position where the answer information exists corresponds to the position of the first target information. That is, the target information in the actual questionnaire may be collectively referred to as first target information. There may be a plurality of first target information.

In the initialization questionnaire, answer information corresponding to each position corresponding to the position where an answer exists in the actual questionnaire is acquired, that is, the second target information corresponding to the location corresponding to the location of the first target information is acquired correspondingly. For example, the position of the i^{th} row and j^{th} column in the initialization questionnaire is the position where answer information exists, which may be represented as Ωᵢⱼ.

The answer information at the corresponding position in the actual questionnaire is determined for each position where the answer information exists in the initialization questionnaire. The target information in the initialization questionnaire may be collectively referred to as the second target information.

A difference calculation is performed on the answer information at the determined position, to obtain an answer information difference matrix. That is, a target information difference matrix is obtained by correspondingly using the first target information and the second target information at the position corresponding to the position of the first target information. The target information difference matrix may be expressed as P_{Ω}(O−X).

An F norm calculation is performed on the target information difference matrix, and is expressed as ∥P_{Ω}(O−X)∥_{F}.

In the embodiment of the present disclosure, the difference between the initialization questionnaire and the actual questionnaire may be represented by ∥P_{Ω}(O−X)∥_{F}².

Through the above scheme, the difference between the initialization questionnaire and the actual questionnaire may be represented in the form of F norm.

In a case where the initialization questionnaire is in a matrix form, the initialization information form may include a first sub-matrix and a second sub-matrix; and

the initialization information form is a product of the first sub-matrix and a transpose matrix of the second sub-matrix.

In a case where the initialization questionnaire is expressed as X, it can be decomposed. The decomposed initialization questionnaire is expressed as X=W̅H̅^{T}. W̅∈R^{m×k} and H̅∈R^{n×k}, k is expressed as a hyper-parameter. That is, W̅ may represent the first sub-matrix, and H̅ may represent the second sub-matrix. In the foregoing formulas, the first sub-matrix and the second sub-matrix are used instead of the initialization questionnaire, to participate in all calculations.

The initialization questionnaire is decomposed to obtain two sub-matrices. By utilizing the similarity between respective users, the low-rank constraint information of the initialization questionnaire, and the relationship between the initialization questionnaire and the actual questionnaire, the initialization questionnaire represented by the two sub-matrices is adjusted, so that the calculation efficiency can be further improved.

If the above decomposed first sub-matrix and second sub-matrix are applied to S301 to S305, the following expression may be written in Formula (9) (Formula (9) in combination with Formula (2), Formula (3)):

Qⱼ₊₁=Z(Z^{T}Qⱼ)=Zₜ₊₁H̅=(I−ηβL)Wₜ(H̅ₜ^{T}H̅)−ηP_{Ω}(WₜHₜ^{Tl-O)H̅}

Qⱼ₊₁=Z(Z^{T}Qⱼ)=((W̅^{T}−ηβL)W^{T})Hₜ^{T}−ηW̅^{T}P_{Ω}(WₜHₜ^{T}−O)

where, L is the Laplacian constraint term l(X) for X in the previous example.

By using this decomposition form, the time complexity of each round is reduced to |Ω|₀+(m+n)k², thereby achieving the efficient solution. |Ω|₀ indicates the number of nonzero values in the calculation questionnaire.

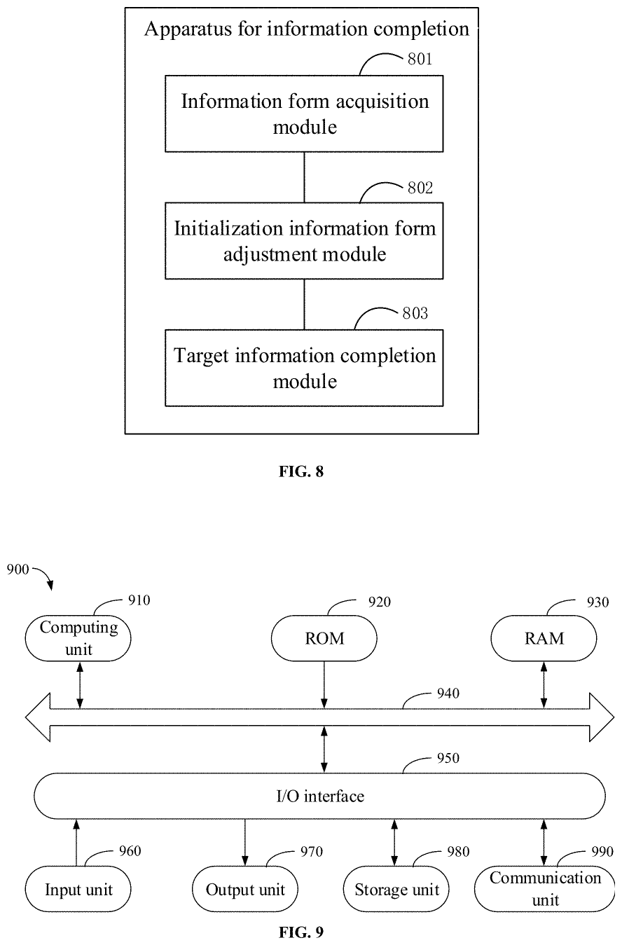

As shown in FIG. 8, the present disclosure provides an apparatus for questionnaire information completion, which may include:

an information form acquisition module 801 configured for acquiring an actual information form and an initialization information form, wherein the actual information form includes an information form which is filled out by a plurality of users and in which target information is missing, and the initialization information form is an information form in which there is target information at each target information position;

an initialization information form adjustment module 802 configured for performing an adjustment on the initialization information form by utilizing a similarity between the users, a low-rank constraint of the initialization information form and a difference between the initialization information form and the actual information form, to obtain an adjusted information form; and

a target information completion module 803 configured for supplementing target information in the adjusted information form to a position where corresponding target information is missing, in the actual information form.

In one embodiment, the initialization information form adjustment module 802 may be specifically configured for: performing the adjustment a plurality of times, and taking an information form obtained after an N^{th} adjustment as the adjusted information form, in a case where the information form obtained after the N^{th} adjustment meets a preset condition, wherein N is a positive integer.

In one embodiment, for an i^{th} adjustment, 0≤i≤N, the initialization information form adjustment module 802 may include:

a gradient descent calculation submodule configured for performing a t^{th} gradient descent calculation on an (i−1)^{th} adjusted information form, to obtain a t^{th} gradient descent calculation result, wherein t is a positive integer greater than 0;

a gradient descent optimization submodule configured for performing a gradient descent optimization by using the t^{th} gradient descent calculation result, to obtain a t^{th} gradient descent optimization result;

a singular value decomposition calculation submodule configured for performing a t^{th} singular value decomposition calculation on the (i−1)^{th} adjusted information form, to obtain a t^{th} singular value decomposition calculation result;

an approximate universal singular value threshold method calculation submodule configured for performing a calculation with an approximate universal singular value threshold method by using the t^{th} gradient descent optimization result and the (t−1)^{th} singular value decomposition calculation result, to obtain a t^{th} approximate universal singular value threshold method calculation result; and

a comparison submodule configured for taking the t^{th} approximate universal singular value threshold method calculation result as the low-rank constraint of the i^{th} adjusted information form, in a case where a difference between the t^{th} approximate universal singular value threshold method calculation result and a (t−1)^{th} approximate universal singular value threshold method calculation result meets a corresponding threshold.

In one embodiment, the performing the calculation with the approximate universal singular value threshold method, may include:

performing feature extraction on the t^{th} gradient descent optimization result and the (t−1)^{th} singular value decomposition calculation result by using a power method, to obtain a feature extraction result;

performing singular value decomposition by using the feature extraction result and the t^{th} gradient descent optimization result, to obtain a singular value decomposition result;

performing low-rank analysis on the singular value decomposition result, to obtain a low-rank analysis result; and

obtaining the approximate universal singular value threshold method calculation result by using the low-rank analysis result.

In one embodiment, the performing feature extraction on the t^{th} gradient descent optimization result and the (t−1)^{th} singular value decomposition calculation result by using the power method, may include:

utilizing an orthogonal triangular decomposition calculation, according to the t^{th} gradient descent optimization result and the (t−1)^{th} singular value decomposition calculation result, to obtain a decomposition result; and

performing a calculation by using the t^{th} gradient descent optimization result, a transposition of the t^{th} gradient descent optimization result and the decomposition result, to obtain the feature extraction result.

In one embodiment, the initialization information form adjustment module 802 may further include:

a feature vector determination submodule configured for determining a feature vector of each of the users;

a distance calculation submodule configured for calculating distances between the feature vectors of the respective users; and

a similarity determination submodule configured for obtaining similarities between the respective users by using the distances.

In one embodiment, the initialization information form adjustment module 802 may further include:

an actual information form information acquisition submodule configured for acquiring a position of a first target information in the actual information form;

an initialization information form information acquisition submodule configured for acquiring, in the initialization information form, a second target information at a position corresponding to the position of the first target information;

a target information difference matrix determination submodule configured for obtaining a target information difference matrix by using the first target information and the second target information at the position corresponding to the position of the first target information; and

a difference determination submodule configured for calculating an F norm of the target information difference matrix, and expressing the difference between the initialization information form and the actual information form by using the F norm of the target information difference matrix.

In one embodiment, in a case where the initialization information form is in a matrix form, the initialization information form may include a first sub-matrix and a second sub-matrix; and

the initialization information form may be a product of the first sub-matrix and a transpose matrix of the second sub-matrix.

In accordance with the embodiments of the present disclosure, the present disclosure also provides an electronic device, a readable storage medium and a computer program product.

FIG. 9 illustrates a schematic block diagram of an example electronic device 900 that may be used to implement embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the present disclosure described and/or claimed herein.

As shown in FIG. 9, the electronic device 900 includes a computing unit 910 that may perform various suitable actions and processes in accordance with computer programs stored in a read only memory (ROM) 920 or computer programs loaded from a storage unit 980 into a random access memory (RAM) 930. In the RAM 930, various programs and data required for the operation of the electronic device 900 may also be stored. The computing unit 910, the ROM 920 and the RAM 930 are connected to each other through a bus 940. An input/output (I/O) interface 950 is also connected to the bus 940.

A plurality of components in the electronic device 900 are connected to the I/O interface 950, including: an input unit 960, such as a keyboard, a mouse, etc.; an output unit 970, such as various types of displays, speakers, etc.; a storage unit 980, such as a magnetic disk, an optical disk, etc.; and a communication unit 990, such as a network card, a modem, a wireless communication transceiver, etc. The communication unit 990 allows the electronic device 900 to exchange information/data with other devices over a computer network, such as the Internet, and/or various telecommunications networks.

The computing unit 910 may be various general purpose and/or special purpose processing assemblies having processing and computing capabilities. Some examples of the computing unit 910 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 910 performs various methods and processes described above, such as the method for information completion. For example, in some embodiments, the method for information completion may be implemented as computer software programs that are physically contained in a machine-readable medium, such as the storage unit 980. In some embodiments, some or all of the computer programs may be loaded into and/or installed on the electronic device 900 via the ROM 920 and/or the communication unit 990. In a case where the computer programs are loaded into the RAM 930 and executed by the computing unit 910, one or more of steps of the method for information completion described above may be performed. Alternatively, in other embodiments, the computing unit 910 may be configured to perform the method for information completion in any other suitable manner (e.g., by means of a firmware).

Various embodiments of the systems and techniques described herein above may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), a computer hardware, a firmware, a software, and/or a combination thereof. These various implementations may include an implementation in one or more computer programs, which can be executed and/or interpreted on a programmable system including at least one programmable processor; the programmable processor may be a dedicated or general-purpose programmable processor and capable of receiving and transmitting data and instructions from and to a storage system, at least one input device, and at least one output device.

The program codes for implementing the methods of the present disclosure may be written in any combination of one or more programming languages. These program codes may be provided to a processor or controller of a general purpose computer, a special purpose computer, or other programmable data processing apparatus such that the program codes, when executed by the processor or controller, enable the functions/operations specified in the flowchart and/or the block diagram to be performed. The program codes may be executed entirely on a machine, partly on a machine, partly on a machine as a stand-alone software package and partly on a remote machine, or entirely on a remote machine or server.

In the context of the present disclosure, the machine-readable medium may be a tangible medium that may contain or store programs for using by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include one or more wire-based electrical connection, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof.

In order to provide an interaction with a user, the system and technology described here may be implemented on a computer having: a display device (e. g., a cathode ray tube (CRT) or a liquid crystal display (LCD) monitor) for displaying information to the user; and a keyboard and a pointing device (e. g., a mouse or a trackball), through which the user can provide an input to the computer. Other kinds of devices can also provide an interaction with the user. For example, a feedback provided to the user may be any form of sensory feedback (e.g., visual feedback, auditory feedback, or tactile feedback); and an input from the user may be received in any form, including an acoustic input, a voice input or a tactile input.

The systems and techniques described herein may be implemented in a computing system (e.g., as a data server) that may include a background component, or a computing system (e.g., an application server) that may include a middleware component, or a computing system (e.g., a user computer having a graphical user interface or a web browser through which a user may interact with embodiments of the systems and techniques described herein) that may include a front-end component, or a computing system that may include any combination of such background components, middleware components, or front-end components. The components of the system may be connected to each other through a digital data communication in any form or medium (e.g., a communication network). Examples of the communication network may include a local area network (LAN), a wide area network (WAN), and the Internet.

The computer system may include a client and a server. The client and the server are typically remote from each other and typically interact via the communication network. The relationship of the client and the server is generated by computer programs running on respective computers and having a client-server relationship with each other.

It should be understood that the steps can be reordered, added or deleted using the various flows illustrated above. For example, the steps described in the present disclosure may be performed concurrently, sequentially or in a different order, so long as the desired results of the technical solutions disclosed in the present disclosure can be achieved, and there is no limitation herein.

The above-described specific embodiments do not limit the scope of the present disclosure. It will be apparent to those skilled in the art that various modifications, combinations, sub-combinations and substitutions are possible, depending on design requirements and other factors. Any modifications, equivalent substitutions, and improvements within the spirit and principles of this disclosure are intended to be included within the scope of the present disclosure.

What is claimed is:

1. A method for information completion, comprising:
acquiring an actual information form and an initialization information form, wherein the actual information form comprises an information form which is filled out by a plurality of users and in which target information is missing, and the initialization information form is an information form in which there is target information at each target information position;
performing an adjustment on the initialization information form by utilizing a similarity between the users, a low-rank constraint of the initialization information form and a difference between the initialization information form and the actual information form, to obtain an adjusted information form; and
supplementing target information in the adjusted information form to a position where corresponding target information is missing, in the actual information form.

2. The method of claim 1, wherein the performing the adjustment on the initialization information form by utilizing the similarity between the users, the low-rank constraint of the initialization information form and the difference between the initialization information form and the actual information form, comprises:
performing the adjustment a plurality of times, and taking an information form obtained after an N^{th} adjustment as the adjusted information form, in a case where the information form obtained after the N^{th} adjustment meets a preset condition, wherein N is a positive integer.

3. The method of claim 2, wherein, for an i^{th} adjustment, 0≤i≤N, a manner for determining the low-rank constraint comprises:
performing a t^{th} gradient descent calculation on an (i−1)^{th} adjusted information form, to obtain a t^{th} gradient descent calculation result, wherein t is a positive integer greater than 0;
performing a gradient descent optimization by using the t^{th} gradient descent calculation result, to obtain a t^{th} gradient descent optimization result;
performing a t^{th} singular value decomposition calculation on the (i−1)^{th} adjusted information form, to obtain a t^{th} singular value decomposition calculation result;
performing a calculation with an approximate universal singular value threshold method by using the t^{th} gradient descent optimization result and the (t−1)^{th} singular value decomposition calculation result, to obtain a t^{th} approximate universal singular value threshold method calculation result; and
taking the t^{th} approximate universal singular value threshold method calculation result as the low-rank constraint of the i^{th} adjusted information form, in a case where a difference between the t^{th} approximate universal singular value threshold method calculation result and a (t−1)^{th} approximate universal singular value threshold method calculation result meets a corresponding threshold.

4. The method of claim 3, wherein the performing the calculation with the approximate universal singular value threshold method, comprises:
performing feature extraction on the t^{th} gradient descent optimization result and the (t−1)^{th} singular value decomposition calculation result by using a power method, to obtain a feature extraction result;
performing singular value decomposition by using the feature extraction result and the t^{th} gradient descent optimization result, to obtain a singular value decomposition result;
performing low-rank analysis on the singular value decomposition result, to obtain a low-rank analysis result; and
obtaining the approximate universal singular value threshold method calculation result by using the low-rank analysis result.

5. The method of claim 4, wherein the performing feature extraction on the t^{th} gradient descent optimization result and the (t−1)^{th} singular value decomposition calculation result by using the power method, comprises:
utilizing an orthogonal triangular decomposition calculation, according to the t^{th} gradient descent optimization result and the (t−1)^{th} singular value decomposition calculation result, to obtain a decomposition result; and
performing a calculation by using the t^{th} gradient descent optimization result, a transposition of the t^{th} gradient descent optimization result and the decomposition result, to obtain the feature extraction result.

6. The method of claim 1, wherein a manner for determining the similarity between the users comprises:
determining a feature vector of each of the users;
calculating distances between the feature vectors of the respective users; and
obtaining similarities between the respective users by using the distances.

7. The method of claim 1, wherein a manner for determining the difference between the initialization information form and the actual information form comprises:
acquiring a position of a first target information in the actual information form;
acquiring, in the initialization information form, a second target information at a position corresponding to the position of the first target information;
obtaining a target information difference matrix by using the first target information and the second target information at the position corresponding to the position of the first target information; and
calculating an F norm of the target information difference matrix, and expressing the difference between the initialization information form and the actual information form by using the F norm of the target information difference matrix.

8. The method of claim 1, wherein, in a case where the initialization information form is in a matrix form, the initialization information form comprises a first sub-matrix and a second sub-matrix; and
the initialization information form is a product of the first sub-matrix and a transpose matrix of the second sub-matrix.

9. An electronic device, comprising:
at least one processor; and
a memory communicatively connected to the at least one processor; wherein,
the memory stores instructions executable by the at least one processor, the instructions being executed by the at least one processor to enable the at least one processor to perform operations of:
acquiring an actual information form and an initialization information form, wherein the actual information form comprises an information form which is filled out by a plurality of users and in which target information is missing, and the initialization information form is an information form in which there is target information at each target information position;
performing an adjustment on the initialization information form by utilizing a similarity between the users, a low-rank constraint of the initialization information form and a difference between the initialization information form and the actual information form, to obtain an adjusted information form; and
supplementing target information in the adjusted information form to a position where corresponding target information is missing, in the actual information form.

10. The electronic device of claim 9, wherein the performing the adjustment on the initialization information form by utilizing the similarity between the users, the low-rank constraint of the initialization information form and the difference between the initialization information form and the actual information form, comprises:
performing the adjustment a plurality of times, and taking an information form obtained after an N^{th} adjustment as the adjusted information form, in a case where the information form obtained after the N^{th} adjustment meets a preset condition, wherein N is a positive integer.

11. The electronic device of claim 10, wherein, for an i^{th} adjustment, 0≤i≤N, a manner for determining the low-rank constraint comprises:
performing a t^{th} gradient descent calculation on an (i−1)^{th} adjusted information form, to obtain a t^{th} gradient descent calculation result, wherein t is a positive integer greater than 0;
performing a gradient descent optimization by using the t^{th} gradient descent calculation result, to obtain a t^{th} gradient descent optimization result;
performing a t^{th} singular value decomposition calculation on the (i−1)^{th} adjusted information form, to obtain a t^{th} singular value decomposition calculation result;
performing a calculation with an approximate universal singular value threshold method by using the t^{th} gradient descent optimization result and the (t−1)^{th} singular value decomposition calculation result, to obtain a t^{th} approximate universal singular value threshold method calculation result; and
taking the t^{th} approximate universal singular value threshold method calculation result as the low-rank constraint of the i^{th} adjusted information form, in a case where a difference between the t^{th} approximate universal singular value threshold method calculation result and a (t−1)^{th} approximate universal singular value threshold method calculation result meets a corresponding threshold.

12. The electronic device of claim 11, wherein the performing the calculation with the approximate universal singular value threshold method, comprises:
performing feature extraction on the t^{th} gradient descent optimization result and the (t−1)^{th} singular value decomposition calculation result by using a power method, to obtain a feature extraction result;
performing singular value decomposition by using the feature extraction result and the t^{th} gradient descent optimization result, to obtain a singular value decomposition result;
performing low-rank analysis on the singular value decomposition result, to obtain a low-rank analysis result; and
obtaining the approximate universal singular value threshold method calculation result by using the low-rank analysis result.

13. The electronic device of claim 12, wherein the performing feature extraction on the t^{th} gradient descent optimization result and the (t−1)^{th} singular value decomposition calculation result by using the power method, comprises:
utilizing an orthogonal triangular decomposition calculation, according to the t^{th} gradient descent optimization result and the (t−1)^{th} singular value decomposition calculation result, to obtain a decomposition result; and
performing a calculation by using the t^{th} gradient descent optimization result, a transposition of the t^{th} gradient descent optimization result and the decomposition result, to obtain the feature extraction result.

14. The electronic device of claim 9, wherein a manner for determining the similarity between the users comprises:
determining a feature vector of each of the users;
calculating distances between the feature vectors of the respective users; and
obtaining similarities between the respective users by using the distances.

15. The electronic device of claim 9, wherein a manner for determining the difference between the initialization information form and the actual information form comprises:
acquiring a position of a first target information in the actual information form;
acquiring, in the initialization information form, a second target information at a position corresponding to the position of the first target information;
obtaining a target information difference matrix by using the first target information and the second target information at the position corresponding to the position of the first target information; and
calculating an F norm of the target information difference matrix, and expressing the difference between the initialization information form and the actual information form by using the F norm of the target information difference matrix.

16. The electronic device of claim 9, wherein, in a case where the initialization information form is in a matrix form, the initialization information form comprises a first sub-matrix and a second sub-matrix; and
the initialization information form is a product of the first sub-matrix and a transpose matrix of the second sub-matrix.

17. A non-transitory computer-readable storage medium storing computer instructions for enabling a computer to perform operations of:
acquiring an actual information form and an initialization information form, wherein the actual information form comprises an information form which is filled out by a plurality of users and in which target information is missing, and the initialization information form is an information form in which there is target information at each target information position;
performing an adjustment on the initialization information form by utilizing a similarity between the users, a low-rank constraint of the initialization information form and a difference between the initialization information form and the actual information form, to obtain an adjusted information form; and
supplementing target information in the adjusted information form to a position where corresponding target information is missing, in the actual information form.

18. The non-transitory computer-readable storage medium of claim 17, wherein the performing the adjustment on the initialization information form by utilizing the similarity between the users, the low-rank constraint of the initialization information form and the difference between the initialization information form and the actual information form, comprises:
performing the adjustment a plurality of times, and taking an information form obtained after an N^{th} adjustment as the adjusted information form, in a case where the information form obtained after the N^{th} adjustment meets a preset condition, wherein N is a positive integer.

19. The non-transitory computer-readable storage medium of claim 18, wherein, for an i^{th} adjustment, 0≤i≤N, a manner for determining the low-rank constraint comprises:
performing a t^{th} gradient descent calculation on an (i−1)^{th} adjusted information form, to obtain a t^{th} gradient descent calculation result, wherein t is a positive integer greater than 0;
performing a gradient descent optimization by using the t^{th} gradient descent calculation result, to obtain a t^{th} gradient descent optimization result;
performing a t^{th} singular value decomposition calculation on the (i−1)^{th} adjusted information form, to obtain a t^{th} singular value decomposition calculation result;
performing a calculation with an approximate universal singular value threshold method by using the t^{th} gradient descent optimization result and the (t−1)^{th} singular value decomposition calculation result, to obtain a t^{th} approximate universal singular value threshold method calculation result; and
taking the t^{th} approximate universal singular value threshold method calculation result as the low-rank constraint of the i^{th} adjusted information form, in a case where a difference between the t^{th} approximate universal singular value threshold method calculation result and a (t−1)^{th} approximate universal singular value threshold method calculation result meets a corresponding threshold.

20. The non-transitory computer-readable storage medium of claim 19, wherein the performing the calculation with the approximate universal singular value threshold method, comprises:
performing feature extraction on the t^{th} gradient descent optimization result and the (t−1)^{th} singular value decomposition calculation result by using a power method, to obtain a feature extraction result;
performing singular value decomposition by using the feature extraction result and the t^{th} gradient descent optimization result, to obtain a singular value decomposition result;
performing low-rank analysis on the singular value decomposition result, to obtain a low-rank analysis result; and
obtaining the approximate universal singular value threshold method calculation result by using the low-rank analysis result.
